(19) United States
(12) Patent Application Publication
(10) Pub. No.: US 2014/0335463 A1
(43) Pub. Date: Nov. 13, 2014

(54) DOMESTIC APPLIANCE AND METHOD

(71) Applicant: BSH Bosch und Siemens Hausgeräte GmbH, Munich (DE)

(72) Inventors: Claudia Sonja Friedrich, Hamburg (DE); Frank Jacob, Hamburg (DE); Andreas Kern, Hamburg (DE); Sören Strayle, Munchen (DE); Kristina Wisch, Hamburg (DE)

(21) Appl. No.: 14/365,137

(22) PCT Filed: Jul. 12, 2012
(86) PCT No.: PCT/EP2012/074830

§ 371 Date: Jun. 16, 2014

(30) Foreign Application Priority Data
Dec. 14, 2011 (DE) 10 2011 088 483.1

(51) Int. Cl. F27D 19/00

(52) U.S. Cl. CPC F27D 19/00
USPC 432/1; 432/32

(57) ABSTRACT

A domestic appliance includes a first display area for displaying first operation settings of the domestic appliance, a first control element for selecting one of the first operation settings, a second display area for displaying second operation settings of the domestic appliance, a second control element for selecting one of the second operation settings. A control facility is provided to allocate a first two-dimensional extent to the first display region and a second two-dimensional extent to the second display region when a user actuates the first operating element and to allocate a third two-dimensional extent to the first display region and a fourth two-dimensional extent to the second display region when the user actuates the second operating element. The third two-dimensional extent is smaller than the first two-dimensional extent and the fourth two-dimensional extent is larger than the second two-dimensional extent.

The present invention relates to a domestic appliance, in particular a cooking appliance, as well as a method for operating a domestic appliance.

Operating facilities for cooking appliances are known. Such operating facilities generally comprise a display facility and an input facility. Different operating modes of the cooking appliance are displayed on the display facility. Such operating modes can be designated for example as “hot air”, “top heat” or “bottom heat” and define the nature and manner of the application of heat to the food being cooked in the cooking compartment. A user can use the input facility to select the operating mode desired in each instance from the different operating modes. It is also generally possible for the user to predetermine a temperature, for example “185° C.”, within the selected operating mode.

The object of the present invention is to provide a domestic appliance, in particular a cooking appliance, which can be operated in a simpler, in particular more intuitive, manner.

To achieve this object, a domestic appliance, in particular a cooking appliance, is proposed with a first display region for displaying first operating settings of the domestic appliance, a first operating element for selecting one of the first operating settings, a second display region for displaying second operating settings of the domestic appliance, a second operating element for selecting one of the second operating settings and a control facility. The control facility is designed to allocate a first two-dimensional extent to the first display region and a second two-dimensional extent to the second display region when the user actuates the first operating element. The control facility is further designed to allocate a third two-dimensional extent to the first display region and a fourth two-dimensional extent to the second display region when the user actuates the second operating element. The third two-dimensional extent is smaller than the first two-dimensional extent and the fourth two-dimensional extent is larger than the second two-dimensional extent.

In other words therefore the display region in which the user wishes to make a selection using the corresponding operating element is always shown enlarged. The respective other display region, in which the user currently does not wish to make a selection, is shown smaller in contrast. The operating setting shown in a respective display region is scaled automatically with the enlargement or reduction of the respective display region; in other words the operating setting is enlarged or reduced along with the respective display region. This means that the information which is the subject of the user interaction with the domestic appliance is always shown enlarged. The observer therefore focuses more on this information. This results in better, more intuitive operation, as it is advantageous from the point of view of the psychology of perception.

According to one embodiment a screen is provided, which comprises the first and second display region. However it is also conceivable for two screens to be provided, with one screen comprising the first display region and the second screen comprising the second display region. The control facility is designed to move the two display regions on the screen (or the two screens, depending on the embodiment) when the user actuates first one operating element and then the other. The movement of the two display regions, in addition to the enlargement or reduction, allows the information which is the subject of the user interaction with the domestic appliance to be positioned in the center of the observer's field of view. This means that the observer focuses on this information to a greater degree.

According to a further embodiment the first two-dimensional extent of the first display region and the fourth two-dimensional extent of the second display region overlap. This “overlap” does not of course ever take place simultaneously, as the first two-dimensional extent and the fourth two-dimensional extent are provided at different time points—on the one hand when the first operating element is actuated and on the other hand when the second operating element is actuated. Rather the “overlap” relates to a surface region, which is occupied by the first two-dimensional extent and the fourth two-dimensional extent, even though at different time points. This has a displacement effect; in other words the information which is the subject of the user interaction with the domestic appliance displaces the previously displayed information spatially. This means that the observer focuses on the current information to an even greater degree.

According to a further embodiment the two display regions each have a reference point. The reference point of the first display region and the reference point of the second display region are at the same distance from one another before and after movement. The first and second display regions are thus moved “with one another”. The reference points can each be provided in the region of a respective corner of the respective display region.

The first operating settings can describe a number of operating modes of the domestic appliance. The operating modes, for example “top heat” or “bottom heat”, which are also referred to as programs, describe a plurality of sequences and/or operating parameters for the domestic appliance. For example the operating mode “top heat” means that power is supplied to a top heating element in a cooking compartment of a domestic appliance configured as an oven. The second operating setting can be assigned to a respective operating mode and describe a physical variable. The assignment can mean for example that the physical variable characterizes the respective operating mode more specifically. If the operating modes are a number of heating modes of a domestic appliance configured as a cooking appliance for example, the physical variable can be a temperature at which the cooking appliance heats. A respective heating mode here defines how the heat is supplied, for example “top heat” or “bottom heat”.

According to another embodiment the domestic appliance is configured as an automatic espresso machine. Here the first operating settings describe standard beverages or individual beverage positions. If the first operating setting “standard beverage” is selected for example, the second operating settings have the positions “espresso”, “latte macchiato”, “cappuccino”, etc.

According to a further embodiment the first operating settings describe a first physical variable and the second operating settings describe a second physical variable. This is particularly useful when the selection of a certain operating mode is excluded from the outset, as can be the case for example with a domestic appliance configured as a microwave.

The domestic appliance is configured for example as a microwave oven or combined microwave and conventional oven. The first physical variable is a power of the microwave oven or combined microwave and conventional oven. The second physical variable is a time period during which the microwave oven or combined microwave and conventional oven emits the power. The power and time period can be set by means of the first or second operating element and are used to activate the magnetron of the microwave oven or combined microwave and conventional oven accordingly.

According to a further embodiment in a first operating mode of the domestic appliance the first operating settings describe a first physical variable. In the first operating mode the second operating settings describe a second physical variable. In a second operating mode of the domestic appliance the first operating settings describe a number of operating modes of the domestic appliance. The second operating settings are assigned to a respective operating mode and describe a physical variable. The domestic appliance can be switched between the first and second operating mode by actuation of the first or second operating element. This allows a consistency or similarity of operation to be achieved even with combined domestic appliances. Such combined domestic appliances combine for example the function of a conventional oven with those of a microwave.

According to a further embodiment the domestic appliance is configured as a combined microwave and conventional oven. The first operating mode is a microwave mode and the second operating mode is a conventional oven mode of the combined microwave and conventional oven. In microwave mode the first physical variable is a power of the combined microwave and conventional oven and the second physical variable is a time period during which the combined microwave and conventional oven emits the power. In conventional oven mode the operating modes comprise a number of heating modes and the physical variable is a temperature at which the combined microwave and conventional oven heats. It is thus possible to switch easily between the different operating modes of a combined microwave and conventional oven without losing the similarity of operation.

The screen is configured for example as a TFT (thin film transistor) screen. The screen can also be configured as a touch screen. The first and/or second operating element can be configured as a rotary selector. The rotary selector can also be configured as a mechanical rotary selector. Alternatively the operating element, in particular a rotary selector, can be configured in the form of soft keys on the touch screen. Actuation of the first or second operating element to switch between the first and second operating mode comprises for example the rotation of a first rotary selector.

According to one embodiment actuation of the first and/or second rotary selector comprises touching and/or rotating the same. For example the first and/or second rotary selector can have a sensor, in particular a capacitive sensor, which registers when the user touches the corresponding rotary selector.

The first display region, the second display region, the first operating element, the second operating element and/or the control device can be integrated in an operating module. Such an operating module can then be used in the same manner in different types of domestic appliance, for example in a combined microwave and conventional oven and an automatic espresso machine.

Alternatively the screen can be configured on the top face of a cooktop, while the rotary selectors are disposed on a front face of the same.

According to one embodiment a front or top face of the domestic appliance can comprise the operating module. This makes the operating module easily accessible.

A method for operating a domestic appliance, in particular a cooking appliance, preferably the inventive domestic appliance, is also proposed. Here a first two-dimensional extent is allocated to a first display region for displaying first operating settings of the domestic appliance and a second two-dimensional extent is allocated to a second display region for displaying second operating settings of the domestic appliance when a user actuates a first operating element to select one of the first operating settings. A third two-dimensional extent is allocated to the first display region and a fourth two-dimensional extent is allocated to the second display region, when a user actuates a second operating element to select one of the second operating settings. The third two-dimensional extent is smaller than the first two-dimensional extent and the fourth two-dimensional extent is larger than the second two-dimensional extent.

The domestic appliance can be configured as a cooking appliance, in particular an oven, cooktop, combined microwave and conventional oven, microwave oven, microwave, steam oven, steam cooker, double oven or automatic espresso machine.

The features described in relation to the domestic appliance apply correspondingly to the method and vice versa.

Further possible implementations of the invention also include not specifically cited combinations of features or embodiments of the domestic appliance or method described above or in the following in relation to the exemplary embodiments. The person skilled in the art will also add or modify individual aspects to improve or supplement the respective basic form of the invention.

Further advantageous configurations and aspects of the invention are set out in the subclaims and in the exemplary embodiments of the invention described in the following. The invention is also described in more detail based on preferred embodiments with reference to the accompanying figures, in which:

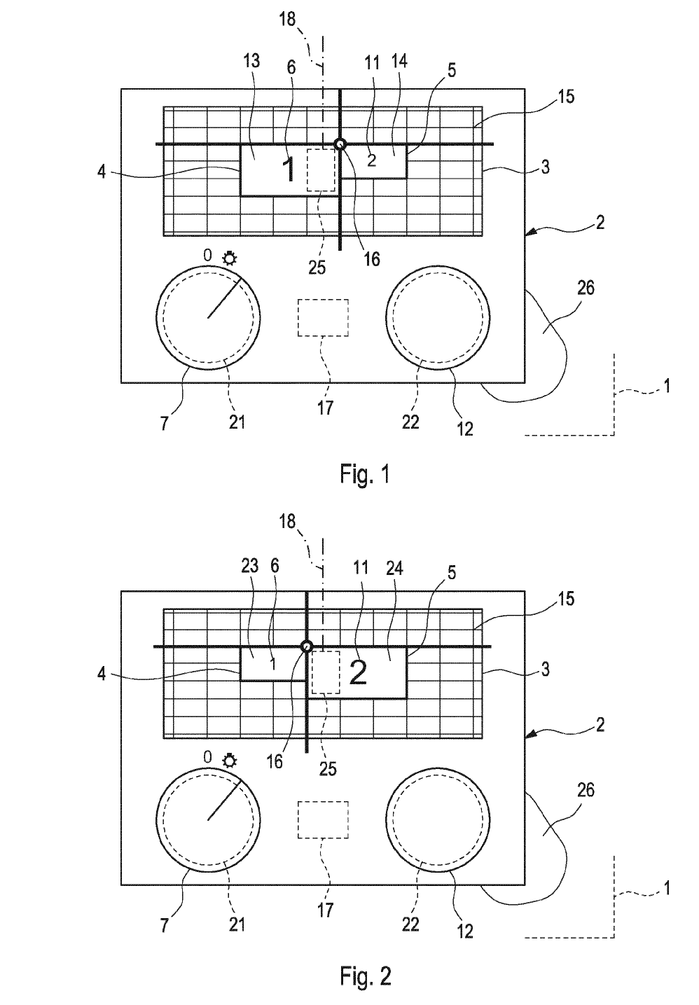

FIG. 1 shows a section of a domestic appliance with an operating module according to an embodiment deemed to be relatively general;

FIG. 2 shows the view from FIG. 1 after actuation of a second operating element;

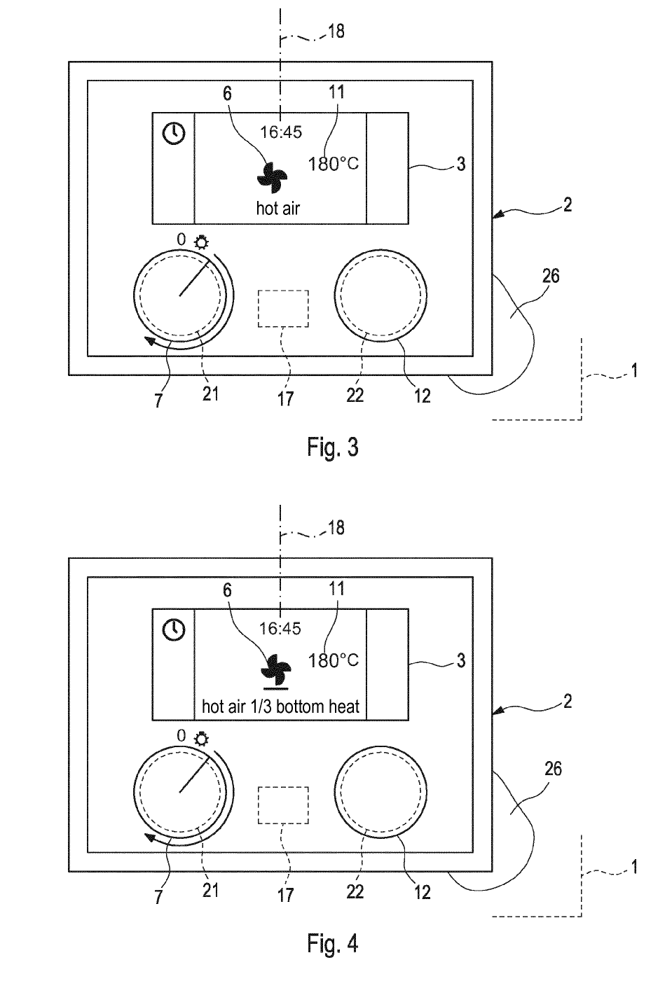

FIG. 3 shows a section of an oven with an operating module according to a more specific embodiment than in FIG. 1;

FIG. 4 shows the view from FIG. 3 after actuation of a first operating element;

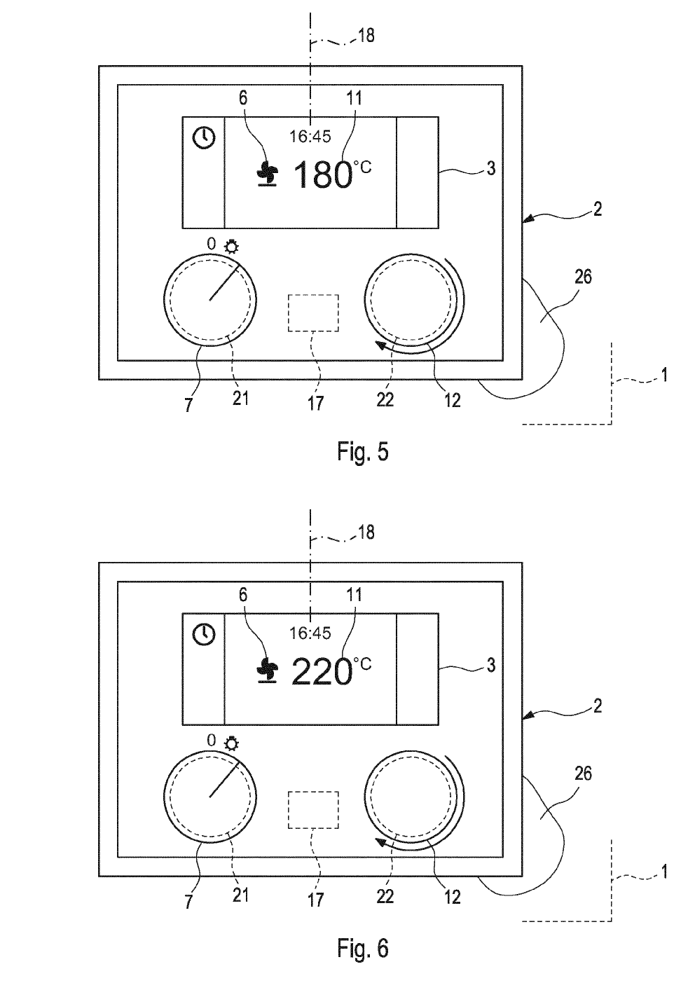

FIG. 5 shows the view from FIG. 4 after actuation of a second operating element;

FIG. 6 shows the view from FIG. 5 after further actuation of the second operating element;

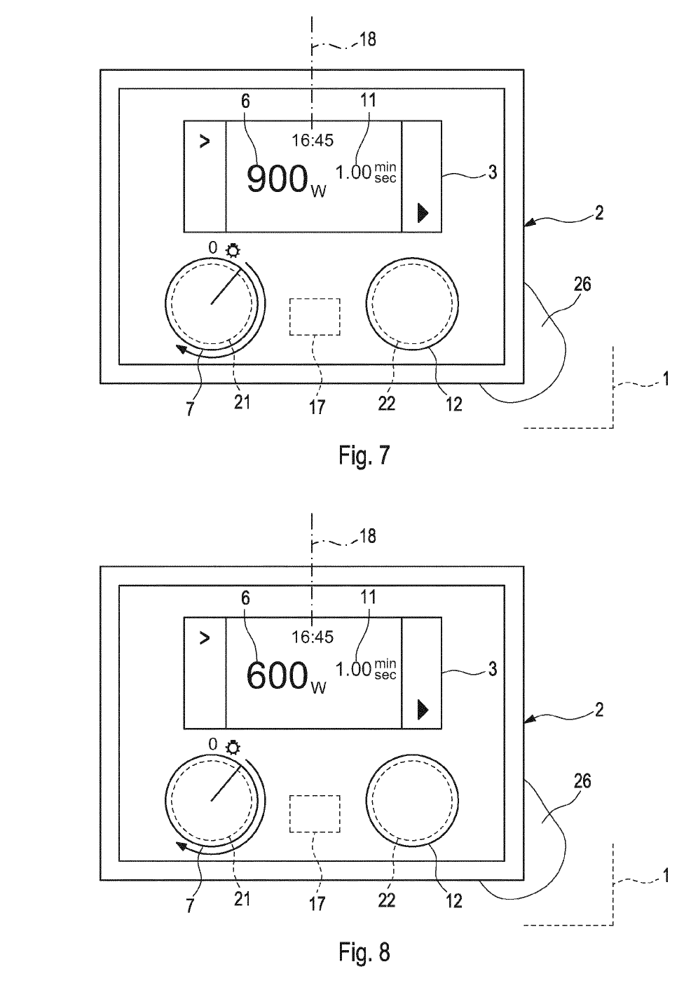

FIG. 7 shows a section of a combined microwave and conventional oven;

FIG. 8 shows the view from FIG. 7 after actuation of the first operating element;

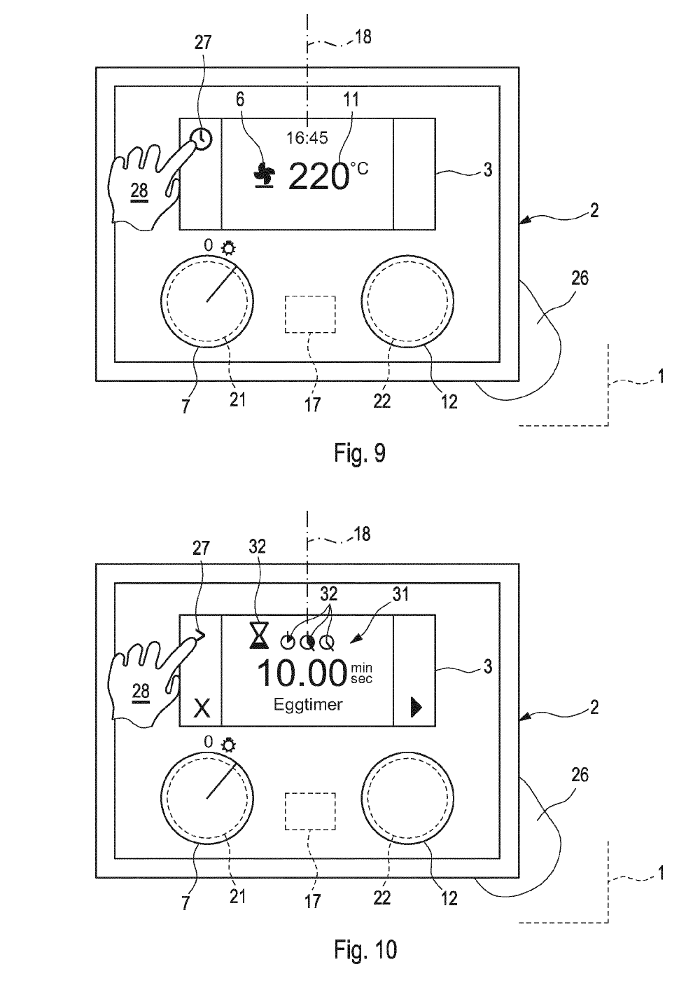

FIG. 9 shows the view from FIG. 6 before actuation of a timer;

FIG. 10 shows the view from FIG. 9 after actuation of the timer;

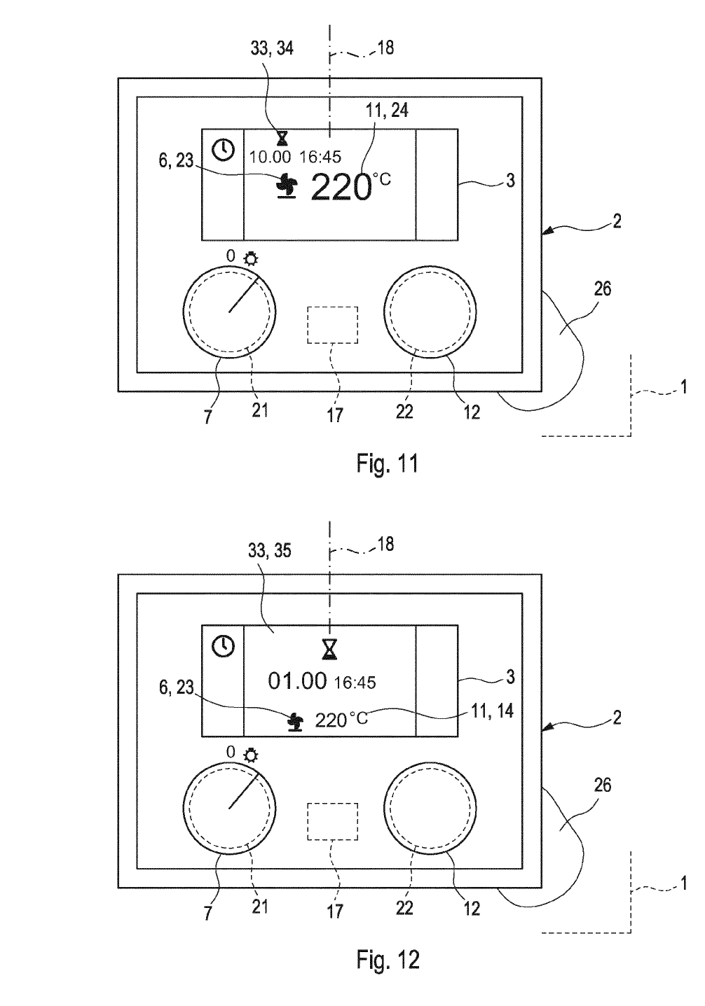

FIG. 11 shows the view from FIG. 10 as the timer counts down; and

FIG. 12 shows the view from FIG. 11 when the timer passes below a predetermined threshold value.

Identical elements or those of identical function are shown with the same reference characters in the figures, unless otherwise stated.

FIG. 1 shows a section through a domestic appliance 1 with an operating module 2 according to an exemplary embodiment deemed to be relatively general.

The operating module 2 comprises a TFT screen 3 with a first display region 4 and a second display region 5.

First operating settings of the domestic appliance 1 can be displayed in the first display region 4. According to the exemplary embodiment however only one of a number of first operating settings is displayed in the first display region 4. To clarify the general nature the figure “1” is shown in the first display region 4 in FIG. 1, designating a first operating setting 6 of the domestic appliance.

The operating module 2 also has a first, mechanical rotary selector 7. By rotating the rotary selector 7 clockwise from its “off” position shown as “0”, in which the domestic appliance 1 is switched off or in standby mode, it is possible to move the rotary selector 7 to a “light on” position, in which a light assigned to the domestic appliance 1, for example in a cooking compartment, is switched on. If the rotary selector 7 is now moved further clockwise, the different operating settings 6 can be displayed in the first display region 4. By rotating the first rotary selector clockwise, it is possible to go through the different first operating settings 6 with just one operating setting 6 always being displayed in the first display region 4 in each instance.

Second operating settings of the domestic appliance can be displayed in the second display region 5. According to the exemplary embodiment only one of a number of second operating settings 11 is always displayed in each instance in the second display region 5. Such a second operating setting 11 is illustrated by the figure “2” in FIG. 1 to show its general nature.

The operating module 2 further comprises a second, mechanical rotary selector 12. Rotation of the second rotary selector 12, for example clockwise, causes the different second operating settings 11 to be displayed in the second display region 5, with just one such second operating setting 11 always being displayed in each instance.

According to the exemplary embodiment the first display region 4 has a first two-dimensional extent 13 and the second display region 5 has a second two-dimensional extent 14, the first two-dimensional extent 13 being larger than the second two-dimensional extent 14. The first operating setting 6 is therefore shown larger than the second operating setting 11.

The first display region 4 and the second display region 5 are each configured as rectangular and aligned on a grid 15 according to the exemplary embodiment. The top right corner of the first display region 4 and the top left corner of the second display region 5 here are located on the same reference point 16.

The operating module 2 also has a control facility 17. The control facility 17 is connected for signal purposes to a first contact sensor 21 and a second contact sensor 22. The first contact sensor 21 is integrated in the first rotary selector 7 and registers when a user's hand touches the first rotary selector 7. The second contact sensor 22 is integrated correspondingly in the second rotary selector 12 and registers when the user's hand touches the second rotary selector 12.

As soon as the user's hand touches the first rotary selector 7, the control facility 17 allocates the first two-dimensional extent 13 to the first display region 4. This assumes that the rotary selector 7 is already in a position assigned to one of the first operating settings, in other words is not in the “off” position. At the same time the control facility 17 allocates the second two-dimensional extent 14 to the second display region 5. The control facility also performs this allocation when the rotary selector 7 is moved clockwise beyond the “light on” position.

By rotating further the user can now select the desired first operating setting 6. The first operating setting 6 is shown larger than the second operating setting 11, see FIG. 1. When the desired first operating setting 6 is displayed, the user's hand moves to the second rotary selector 12, to select a second operating setting 11 from the number of second operating settings 11. As soon as the user's hand touches the second rotary selector 12, the control facility 17 allocates a third two-dimensional extent 23 to the first display region 4 and a fourth two-dimensional extent 24 to the second display region 5. The third two-dimensional extent 23 is smaller than the first two-dimensional extent 13. The fourth two-dimensional extent 24 is also larger than the second two-dimensional extent 14. The first operating setting 6 is therefore shown smaller than was the case still in the state shown in FIG. 1 before the second rotary selector 12 was touched. Also in the state shown in FIG. 2 after actuation of the rotary selector 12 the second operating setting 11 is shown larger than was the case still in the state shown in FIG. 1 before the second rotary selector 12 was touched. Also in the state shown in FIG. 2 after the second rotary selector 12 has been touched the second operating setting 11 is shown larger than the first operating setting 6. The operating setting 6, 11 shown in a respective display region 4, 5 scales automatically with the enlargement or reduction of the respective display region 4, 5.

If the second rotary selector 12 is now rotated clockwise for example, the different second operating settings 11 are shown in the second display region 5, with only one being displayed in each instance.

If the rotary selectors 7, 12 are not actuated further, the domestic appliance 1, for example a cooking compartment of the same, is activated by the control facility 17 with the first selected (displayed) operating setting 6 and the second selected (displayed) operating setting 11.

Also the control facility 17 moves the reference point 16 according to the exemplary embodiment to the left, so that the first and second display region 4, 5 are moved to the left. This moves the second display region 5 more toward the center 18 of the screen 3 and therefore into the center of the field of view of the observer. It can also be seen from a comparison of FIGS. 1 and 2 that the first two-dimensional extent 13 of the first display region 4 has a region 25, which overlaps with the fourth two-dimensional extent 24 of the second display region 5.

The operating module 2 can be integrated for example into a front face 26, see FIG. 1.

The screen 3, the rotary selectors 7, 12 and the control facility 17 do not have to be combined in an operating module 2 but can also be integrated separately into the domestic appliance 1.

The domestic appliance 1 can be a cooking appliance, in particular an oven, a combined microwave and conventional oven, a microwave, a steam oven, a steam cooker or a double oven or an automatic coffee machine, in particular an automatic espresso machine. The operating module 2 described above can be used in the same manner in said domestic appliances.

Use of the operating module 2 in an oven is described in more detail below with reference to FIGS. 3 to 6.

Clockwise actuation (see arrow) of the first rotary selector 7 in FIG. 3 causes different first operating settings 6 in the form of heating modes of the oven to be displayed. Therefore it reads “hot air” for example in FIG. 3 while in FIG. 4 it reads “hot air ⅓ bottom heat”. The corresponding symbol in FIG. 4 is also different from the one in FIG. 3.

The second operating setting 11, in the form of a temperature at which the oven is operated, remains the same, for example “180°”, as shown in FIGS. 3 and 4.

If the user's hand now moves to the second rotary selector 12, when this is touched or, depending on the embodiment, just when it is rotated, the temperature 11 is shown large and moved toward the center 18 of the screen 3. The heating mode 6 is therefore reduced and shown away from the center 18, in the present instance moved to the left. If the second rotary selector 12 is now rotated clockwise (see arrow) the user can increase or reduce the temperature 11, as shown in FIG. 6. The temperature 11 is thus increased from “180°” to “220°” according to the exemplary embodiment.

A use of the operating module 2 in a domestic appliance 1 in the form of a combined microwave and conventional oven is explained with reference to FIGS. 7 and 8. Only the differences compared with the exemplary embodiment according to FIGS. 3 to 6 are examined here.

The first operating setting 6 displayed is a power in watts for example, at which a magnetron integrated in the combined microwave and conventional oven 1 is operated. When the rotary selector 7 is actuated clockwise, the displayed wattage 6 decreases. Thus for example the displayed power in FIGS. 7 and 8 decreases from “900” watts to “600” watts. When the desired wattage 6 is set, the user's hand moves to the second rotary selector 12. Just touching or, depending on the embodiment, rotating said selector causes a second operating setting 11 in the form of a time, in the present exemplary embodiment “1.00” minutes, to be shown larger and moved toward the center 18, while the wattage 6 is reduced and shown away from the center 18 to the left and smaller. This is not shown in any of the figures but corresponds to the diagram from FIG. 6.

The combined microwave and conventional oven 1 comprises a first operating mode, in which it can be operated as a microwave appliance, and a second operating mode, in which it can be operated as a conventional oven. FIGS. 3-6 show conventional oven mode, while FIGS. 7 and 8 illustrate microwave mode.

When the first rotary selector 7 is moved further clockwise in FIG. 8, the combined microwave and conventional oven 1 switches from the microwave mode shown in FIGS. 7 and 8 to the conventional oven mode shown in FIGS. 3 to 6. The first rotary selector 7 can then be used to select the different heating modes, while the second rotary selector 12 can be used to select the temperature 11. The combined microwave and conventional oven 1 can therefore be operated in the same manner in microwave mode and conventional oven mode.

FIG. 9 shows how the user's hand 28 can actuate a soft key 27 on the screen 3 to call up a timer menu 31 (see FIG. 10) on the screen 3 from the state shown in FIG. 6. Actuation of the soft key 27 allows a selection to be made between different timer settings 32, with the timer setting 32 selected in each instance being shown larger than the other timer settings 32. Thus the egg timer is shown larger than the other symbols in FIG. 10.

In FIG. 11 the remaining timer time is shown in a further display region 33 of the screen 3. As can be seen from a comparison of FIGS. 11 and 12, in the state shown in FIG. 11 the display region 33 has a first two-dimensional extent 34 and in the state shown in FIG. 12 it has a second two-dimensional extent 35. The second two-dimensional extent 35 here is larger than the first two-dimensional extent 34. Also in the state shown in FIG. 11 the temperature 11 is still shown with its large, fourth two-dimensional extent 24, while the heating mode 6 is shown with its reduced second two-dimensional extent 23. In the state in FIG. 12 the heating mode 6 and temperature 11 are shown further down the screen 3, the temperature 11 also having its second two-dimensional extent 14. The allocation of the respective two-dimensional extents 14, 23, 24, 34, 35 from the state shown in FIG. 11 to the state shown in FIG. 12 is performed by the control facility 17 and takes place when the remaining time is less than or equal to a predetermined threshold value, for example “1.00” minutes in the present instance.

The rotary selectors 7, 12, which are configured mechanically according to the exemplary embodiment, could also be configured for example as part of the screen 3, which in this instance is configured at least in parts as a touch screen. The rotary selectors 7, 12 would then be configured as what are known as soft keys. If actuation of the first and second rotary selector 7, 12 is not provided by touching but by rotating the same, the contact sensors 21, 22 are not required.

Although the present invention has been described with reference to exemplary embodiments, it can be modified in many ways.

### REFERENCE CHARACTERS USED

1 Domestic appliance

2 Operating module

3 Screen

4 First display region

5 Second display region

6 First operating setting

7 First rotary selector

11 Second operating setting

12 Second rotary selector

13 First two-dimensional extent

14 Second two-dimensional extent

15 Grid

16 Reference point

17 Control facility

18 Center

21 First contact sensor

22 Second contact sensor

23 Third two-dimensional extent

24 Fourth two-dimensional extent

25 Region

26 Front face

27 Soft key

28 Hand

31 Timer menu

32 Timer setting

33 Display region

34 First two-dimensional extent

35 Second two-dimensional extent

1-15. (canceled)

16. A domestic appliance, comprising:
a first display region configured to display first operating settings;
a first operating element configured to select one of the first operating settings;
a second display region configured to display second operating settings;
a second operating element configured to select one of the second operating settings; and
a control facility configured to allocate a first two-dimensional extent to the first display region and a second two-dimensional extent to the second display region when a user actuates the first operating element and to allocate a third two-dimensional extent to the first display region and a fourth two-dimensional extent to the second display region when the user actuates the second operating element, said third two-dimensional extent being smaller than the first two-dimensional extent and said fourth two-dimensional extent being larger than the second two-dimensional extent.

17. The domestic appliance of claim 16, further comprising a screen which comprises the first and second display regions, said control facility being configured to move the first and second display regions on the screen when the user actuates the first operating element and then the second operating element.

18. The domestic appliance of claim 16, wherein the first two-dimensional extent of the first display region and the fourth two-dimensional extent of the second display region overlap.

19. The domestic appliance of claim 17, wherein the first and second display regions each have a reference point, with the reference point of the first display region and the reference point of the second display region having a same distance from one another before and after movement.

20. The domestic appliance of claim 16, wherein the first operating settings describe a number of operating modes of the domestic appliance, and the second operating settings are assigned to the operating modes, respectively, and describe a physical variable.

21. The domestic appliance of claim 20, constructed in the form of a cooking appliance, wherein the operating modes comprise a number of heating modes of the cooking appliance, and wherein the physical variable is a temperature at which the cooking appliance heats.

22. The domestic appliance of claim 16, wherein the first operating settings describe a first physical variable and the second operating settings describe a second physical variable.

23. The domestic appliance of claim 22, constructed in the form of a microwave oven or combined microwave and conventional oven, wherein the first physical variable is a power of the microwave oven or combined microwave and conventional oven and the second physical variable is a time period during which the microwave oven or combined microwave and conventional oven emits the power.

24. The domestic appliance of claim 16, wherein in a first operating mode of the domestic appliance the first operating settings describe a first physical variable and the second operating settings describe a second physical variable, and wherein in a second operating mode of the domestic appliance the first operating settings describe a number of operating modes of the domestic appliance and the second operating settings are assigned to operating modes, respectively, and describe a physical variable, with the domestic appliance being switchable between the first and second operating modes by actuation of the first or second operating elements.

25. The domestic appliance of claim 24, constructed in the form of a combined microwave and conventional oven, wherein the first operating mode is a microwave mode and the second operating mode is a conventional oven mode of the combined microwave and conventional oven, wherein in the microwave mode the first physical variable is a power of the combined microwave and conventional oven and the second physical variable is a time period during which the combined microwave and conventional oven emits the power, and wherein in the conventional oven mode the first and second operating modes comprise a number of heating modes, with the physical variable being a temperature at which the combined microwave and conventional oven heats.

26. The domestic appliance of claim 17, wherein the screen is configured as a TFT screen.

27. The domestic appliance of claim 16, wherein at least one of the first and second operating elements is configured as a rotary selector.

28. The domestic appliance of claim 27, wherein the rotary selector is actuated by touching or rotation thereof.

29. The domestic appliance of claim 16, wherein the first display region, the second display region, the first operating element, the second operating element and/or the control device are integrated in an operating module.

30. The domestic appliance of claim 29, wherein the operating module is provided in a front or top face of the domestic appliance.

31. A method for operating a domestic appliance, comprising:
allocating a first two-dimensional extent to a first display region for displaying first operating settings of the domestic appliance and allocating a second two-dimensional extent to a second display region for displaying second operating settings of the domestic appliance, when a user actuates a first operating element to select one of the first operating settings;
allocating a third two-dimensional extent to the first display region and allocating a fourth two-dimensional extent to the second display region, when the user actuates a second operating element to select one of the second operating settings,
wherein the third two-dimensional extent is smaller than the first two-dimensional extent and the fourth two-dimensional extent is larger than the second two-dimensional extent.

32. The method of claim 31 for operating a cooking appliance.

33. The method of claim 31, further comprising moving the first and second display regions on a screen when the user actuates the first operating element and then the second operating element.

34. The method of claim 31, wherein the first two-dimensional extent of the first display region and the fourth two-dimensional extent of the second display region overlap.

35. The method of claim 34, wherein the first and second display regions each have a reference point, with the reference point of the first display region and the reference point of the second display region having a same distance from one another before and after movement.

36. The method of claim 31, further comprising assigning the second operating settings to a number of operating modes, with the second operating settings describing a physical variable.

37. The method of claim 36, wherein the domestic appliance is constructed in the form of a cooking appliance, wherein the operating modes comprise a number of heating modes of the cooking appliance, and wherein the physical variable is a temperature at which the cooking appliance heats.

38. The method of claim 31, wherein the first operating settings describe a first physical variable and the second operating settings describe a second physical variable.

39. The method of claim 38, wherein the domestic appliance is constructed in the form of a microwave oven or combined microwave and conventional oven, wherein the first physical variable is a power of the microwave oven or combined microwave and conventional oven and the second physical variable is a time period during which the microwave oven or combined microwave and conventional oven emits the power.

40. The method of claim 31, wherein in a first operating mode the first operating settings describe a first physical variable and the second operating settings describe a second physical variable, and wherein in a second operating mode of the method the first operating settings describe a number of operating modes of the domestic appliance and the second operating settings are assigned to operating modes, respectively, and describe a physical variable, with the domestic appliance being switchable between the first and second operating modes by actuation of the first or second operating elements.

41. The method of claim 40, wherein the domestic appliance is constructed in the form of a combined microwave and conventional oven, wherein the first operating mode is a microwave mode and the second operating mode is a conventional oven mode of the combined microwave and conventional oven, wherein in the microwave mode the first physical variable is a power of the combined microwave and conventional oven and the second physical variable is a time period during which the combined microwave and conventional oven emits the power, and wherein in the conventional oven mode the first and second operating modes comprise a number of heating modes, with the physical variable being a temperature at which the combined microwave and conventional oven heats.

42. The method of claim 33, wherein the screen is configured as a TFT screen.

43. The method of claim 31, wherein at least one of the first and second operating elements is configured as a rotary selector.

44. The method of claim 43, further comprising actuating the rotary selector by touching or rotation thereof.

45. The method of claim 31, further comprising integrating the first display region, the second display region, the first operating element, the second operating element and/or the control device in an operating module.

46. The method of claim 45, further comprising providing the operating module in a front or top face of the domestic appliance.
